(19) United States
(12) Patent Application Publication
(10) Pub. No.: US 2005/0266171 A1
(43) Pub. Date: Dec. 1, 2005

(54) Process and plant for coating a molded article

(75) Inventors: Fumihito Noguchi, Aichi-ken (JP); Yasuhiko Ogisu, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD.

(21) Appl. No.: 11/135,424

(22) Filed: May 24, 2005

(30) Foreign Application Priority Data
May 31, 2004 (JP) 2004-161389

(51) Int. Cl. B05D 3/00; B29C 71/02

(52) U.S. Cl. 427/532; 427/508; 118/620

(57) ABSTRACT

A process and a plant for coating a molded article, which are enabled by eliminating the stocking to make the equipment arrangement space compact, to reduce the stocking troubles, and to shorten the lead time, and which are enabled by substantially synchronizing the cycle times of the individual processes including the drying cycle time to realize one transfer of the molded articles, and to make the drying equipment compact and highly efficient. The process for coating the molded article comprises a coating process for coating the molded article molded of a polymer material with an ultraviolet (UV) curable coating material, and a curing process for curing the UV curable coating material by a UV irradiation. A coating cycle time of the coating process and a curing cycle time of the curing process are individually set within a range of 0.2 times to five times with respect to the molding cycle time of the molded article, so that the molded article is sequentially transferred one by one to the coating process and the curing process thereby to eliminate any stocking between the individual processes.

### BACKGROUND OF THE INVENTION

1. Field of the Invention

The present invention relates to a process and a plant for coating various kinds of molded articles such as exterior trim parts of automobiles made of a polymer material.

2. Description of the Related Art

The molded article coating plant of the prior art is independent of a molding plant, and a stock site is disposed between the two plants. As shown in FIG. 15, molded articles molded of a polymer material by a molding apparatus 100 in the molding plant are once placed and stocked massively in a stock site 101. A predetermined number of molded articles are extracted from that stock and transferred to the coating plant, subjected to a pretreatment (e.g., a cleaning treatment) by a pretreatment booth 102 of the coating plant, and coated with a coating material by a coating booth 103, and the coating material is dried by a drying oven 104.

In the related art, most of the coating material are of the thermosetting type so that a drying equipment is exemplified by one using an IR (Infrared Ray) irradiation or a hot wind blow. Therefore, the drying cycle time is especially elongated to make the cycle times of the individual processes become drastically different. FIG. 16 shows one example of the cycle times (i.e., the time periods for one molded article to be treated at the individual processes) of the individual processes in the molding plant and the coating plant in the exterior trim parts of the automobile. The molding cycle time at the molding process is about 1.5 minutes (e.g., 1 to 2 minutes), but the base coat (BC) coating cycle time at the BC coating process of coating with a base coat coating material is about minute, a clear (CL) coating cycle time at a CL coating process of coating with a clear (CL) coating material is about 1 minute, and a drying cycle time at a drying process of drying those base coat coating material and the CL coating material by an IR irradiation is about 30 to 40 minutes. It takes no long time depending on the selection of the coating material to dry the base coat coating material. In most cases, however, the CL coating material is exemplified by a two-liquid type thermosetting coating material composed of a main agent and a setting agent, and its drying operation takes a long time, so that the drying cycle time becomes long. If the drying equipment is so small that it accepts a limited number of molded articles, the drying process cannot follow up the coating process. Therefore, the drying equipment is specified so long as to accept a number of molded articles at once.

Moreover, the coating material is also exemplified by an ultraviolet (UV) curable type, which has hardly been used as the molded article such as the exterior trim parts of automobiles to be exposed to the solar ray. The reasons for this are explained in the following. Firstly, when the UV curable coating material is irradiated with the UV, a considerably strong UV has to be emitted to reach the individual portions of the molded article. Then, the temperature of the molded article may rise to 120° C. or higher so that the molded article may be thermally deformed. Secondly, it is necessary to blend the UV curable coating material with a UV absorbent for a weather resistance. However, the UV absorbent absorbs the ultraviolet ray to act on the photopolymerization initiator which is blended for the UV curing purpose, and obstructs the curing treatment. Therefore, the UV absorbent cannot be blended at all. However, since this second problem is caused by the overlap of the absorbent band of the UV absorbent and the excitation band of the photopolymerization initiator, it can be solved to blend the UV absorbent by shifting the absorption band and the excitation band. In the exterior trim parts of the automobile, therefore, there has been investigated the use of the UV curable coating material. In Japanese Laid-open Patent Publication Number hei 04-341360 (No. JP-A-4-341360), for example, there is disclosed a coating film providing plant, which comprises: a work mounting/demounting area for the worker to place a molded article such as a head lamp for an automobile on a spindle type holder; a coating equipment for coating the molded article with a UV curable coating material; a drying equipment for volatilizing a solvent in the UV curable coating material; and a UV irradiation equipment for irradiating the UV curable coating material with the UV to cure the coating material.

### SUMMARY OF THE INVENTION

As described above, the molded article coating plant of the related art is independent of the molding plant to have a stock site inbetween, so that the following problems arise.
(a1) The equipment arrangement needs a large space.
(a2) It takes troubles to stock and extract the molded articles in the stock site 101.
(a3) The molded articles stocked in the stock site 101 catch dust or the like on their surfaces, and a pretreatment is needed at the pretreatment booth 102 before the coating operation.
(a4) A lead time (i.e., the total time period till the drying operation is completed from the molding process through the coating process) is elongated.

The following problems arise in the coating process and the coating plant of the related art using the aforementioned thermosetting type coating material, because the drying cycle time is especially long.
(b1) If the drying oven 104 is so small that it can accept a small number of molded articles at once, the drying process cannot follow up the coating process so that the molded articles cannot smoothly flow to deteriorate the efficiency.
(b2) On the other hand, if the drying oven 104 is so long that a number of molded articles are brought at once into it, the equipment arrangement needs a large space.

The following problems also arise in the coating film providing plant using the aforementioned UV curable coating material, as described in No. JP-A-4-341360.
(c1) It is deemed that the coating film providing plant is also independent of the molding plant, and that the stock site 101 is disposed between the two plants. Hence, the coating film providing plant has problems like the aforementioned ones (a1) to (a4).
(c2) The drying cycle time for volatilizing the solvent in the UV curable coating material is long to raise problems like the aforementioned ones (b1) and (b2).

An object of the invention is to solve the problems thus far described and to provide a process and a plant for coating a molded article, which are enabled by eliminating the stock site to make the equipment arrangement space compact, to reduce the troubles of a stock site, and to shorten the lead time, and which are enabled by substantially synchronizing the cycle times of the individual processes including the drying cycle time to realize one transfer of the molded articles, and to make the drying equipment compact and highly efficient.

The process for coating a molded article according to the invention adopts the following means [1] to [3].

[1] A process for coating a molded article which comprises a coating process of coating a molded article molded of a polymer material with an ultraviolet (UV) curable coating material, and a curing process of curing the UV curable coating material by a UV irradiation. A coating cycle time of the coating process and a curing cycle time of the curing process are individually set within a range of 0.2 times to five times (preferably, a range of 0.5 times to two times) with respect to a molding cycle time of the molded article, whereby the molded article is sequentially transferred one by one to the coating process and the curing process thereby to eliminate any stocking between the individual processes.

[2] A process for coating a molded article according to aforementioned [1] which further comprises a base coat (BC) coating process of coating the molded article with a base coat coating material. The BC coating process is operated prior to the coating process. A BC coating cycle time of the BC coating process is set within a range of 0.2 times to five times (preferably, a range of 0.5 times to two times) with respect to the molding cycle time of the molded article, whereby the molded article is sequentially transferred one by one to the BC coating process, the coating process, and the curing process thereby to eliminate any stocking between the individual processes.

[3] A process for coating a molded article according to aforementioned [2] which further comprises a drying process of drying the base coat coating material by heating the same. The drying process is operated after the BC coating process and prior to the coating process. A drying cycle time of the drying process is set within a range of 0.2 times to five times (preferably, a range of 0.5 times to two times) with respect to the molding cycle time of the molded article, whereby the molded article is sequentially transferred one by one to the BC coating process, the drying process, the coating process, and the curing process thereby to eliminate any stocking between said individual processes.

The plant for coating the molded article according to the invention adopts the following means [4] to [8].

[4] A plant for coating a molded article which comprises an unloader for unloading a molded article from a molding apparatus for molding the molded article of a polymer material, a coating equipment for coating the molded article with an ultraviolet (UV) curable coating material, a curing equipment for curing the UV curable coating material by a UV irradiation, and a transfer equipment for transferring the molded article automatically between the individual equipments. The unloader, the coating equipment and the curing equipment are sequentially arranged in the recited order from the molding apparatus through no stock site between any ones of the individual equipments. A coating cycle time by the coating equipment and a curing cycle time by said curing equipment are individually set within a range of 0.2 times to five times (preferably, a range of 0.5 times to two times) with respect to a molding cycle time by the molding apparatus.

[5] A plant for coating a molded article according to aforementioned [4] which further comprises a base coat (BC) coating equipment for coating the molded article with a base coat coating material. The BC coating equipment is arranged between the unloader and the coating equipment through no stock site between any ones of the individual equipments. The transfer equipment transfers the molded article automatically between the individual equipments. A BC coating cycle time by the BC coating equipment is set within a range of 0.2 times to five times (preferably, a range of 0.5 times to two times) with respect to the molding cycle time by the molding apparatus.

[6] A plant for coating a molded article according to aforementioned [5] which further comprises a drying equipment for drying the base coat coating material by heating the same. The drying equipment is arranged between the BC coating equipment and the coating equipment through no stock site between any ones of the individual equipments. The transfer equipment transfers the molded article automatically between said individual equipments. A drying cycle time by the drying equipment is set within a range of 0.2 times to five times (preferably, a range of 0.5 times to two times) with respect to the molding cycle time by the molding apparatus.

[7] A plant for coating a molded article which comprises an unloader for unloading a molded article molded of a polymer material from a molding apparatus, a base coat (BC) coating equipment for coating the molded article with a base coat coating material, a drying equipment for drying the base coat coating material by heating the same, a coating equipment for coating the molded article with an ultraviolet (UV) curable coating material, and a curing equipment for curing the UV curable coating material by a UV irradiation. The unloader, the BC coating equipment, the drying equipment, the coating equipment, and the curing equipment are individually constructed as units. The units of the individual equipments are so interchangeably assembled as to make the following three arrangements selectively:
(1) the unloader, the BC coating equipment, the drying equipment, the coating equipment and the curing equipment are sequentially arranged and jointed in the recited order;
(2) the unloader, the coating equipment and the curing equipment are sequentially arranged and jointed in the recited order excepting the BC coating equipment and the drying equipment; or
(3) the unloader, the BC coating equipment, the coating equipment and the curing equipment are sequentially arranged and jointed in the recited order excepting the drying equipment.

[8] A plant for coating a molded article according to aforementioned [7], wherein the units of the individual equipments are formed to have generally rectangular box-shaped casings, and one side face of another unit can be jointed to a selected one of two or three side faces of at least one unit, whereby the plan arrangement of the individual units can be changed.

The aforementioned individual means may employ either of a solvent type UV curable coating material (of a general type) containing a solvent or a solventless UV curable coating material containing no solvent. However, the employment of the substantially solventless type is preferred in that the solvent volatilizing process after the coating is not needed, and that the adjustment of the solvent in the recovered coating material is not needed. The substantially solventless type means not only one containing no solvent but also one containing a small amount of solvent (requiring no adjustment of the solvent in the recovered coating material).

The UV curable coating material may be exemplified by either a colored color coating material or a transparent clear coating material. However, the employment of the clear coating material is preferred because of no trouble about the correction of a color mixing or a color dispersion.

According to the process and the plant for coating the molded article of the present invention, it is enabled by eliminating the stock site to make the space for the equipment arrangement compact, to reduce the stocking troubles, and to shorten the lead time. It is also enabled by substantially synchronizing the cycle times of the individual processes including the drying cycle time to realize a one-piece transfer of the molded articles, and to make the drying equipment compact and highly efficient.

### BRIEF DESCRIPTION OF THE DRAWINGS

FIG. 1 is a perspective view schematically showing the entireties of a molding apparatus and a coating plant of Embodiment 1 according to the invention through casings;

FIG. 2 is a plan view schematically showing the entirety of the coating plant through the casings;

FIG. 3A is a plan view showing a coating equipment of the coating plant through a casing;

FIG. 3B is a side view of FIG. 3A;

FIG. 4 is a longitudinal sectional view of a UV curable coating material recovery equipment connected to the same coating equipment;

FIG. 5 is a transverse sectional view of the same UV curable coating material recovery equipment;

FIG. 6 is a sectional view showing the actions of the same UV curable coating material recovery equipment;

FIGS. 7A and 7B are perspective views showing a curing equipment of the same coating plant through a casing;

FIG. 8 is a perspective view showing a lamp mover of the same curing equipment;

FIG. 9 is a perspective view showing an action by the same curing equipment;

FIG. 10 is a perspective view showing another action by the same curing equipment;

FIG. 11A is a perspective view showing still another action by the same curing equipment;

FIG. 11B is a side view of FIG. 11A;

FIG. 12 is a graph showing the cycle times of the individual processes of the same coating plant;

FIGS. 13A, 13B, and 13C are schematic plan views showing modes of arrangement of the individual equipments of the same coating plant;

FIGS. 14A, 14B, and 14C are schematic plan views showing other modes of arrangement of the individual equipments of the same coating plant;

FIG. 15 is a plan view schematically showing the entireties of a molding apparatus and a coating plant of the related art; and

FIG. 16 is a graph showing the cycle times of the individual processes of the coating plant of the related art.

### DESCRIPTION OF THE PREFERRED EMBODIMENTS

A plant for coating a molded article is provided with: an unloader (10) for unloading a molded article (A) from a molding apparatus (1); a base coat (BC) coating equipment (20) for coating the molded article (A) with a base coat coating material; a drying equipment (30) for drying the base coat coating material by heating it; a coating equipment (40) for coating the molded article (A) with an ultraviolet (UV) curable coating material; and a curing equipment (50) for curing the UV curable coating material by a UV irradiation. These equipments (10), (20), (30), (40) and (50) are arranged in the recited order from the molding apparatus (1) for molding the molded article (A) of a polymeric material and without any stock site between any two of the equipments. The plant for coating a molded article is further provided with a transfer equipment (70) for transferring the molded article automatically between the individual equipments. The BC coating cycle time by the BC coating equipment (20), the drying cycle time by the drying equipment (30), the coating cycle time by the coating equipment (40) and the curing cycle time by the curing equipment (50) are individually set within a range of 0.2 to 5 times with respect to the molding cycle by the molding apparatus (1). These processes are performed without any stocking inbetween by transferring the molded article sequentially one by one among the BC coating process, the drying process, the coating process, and the curing process.

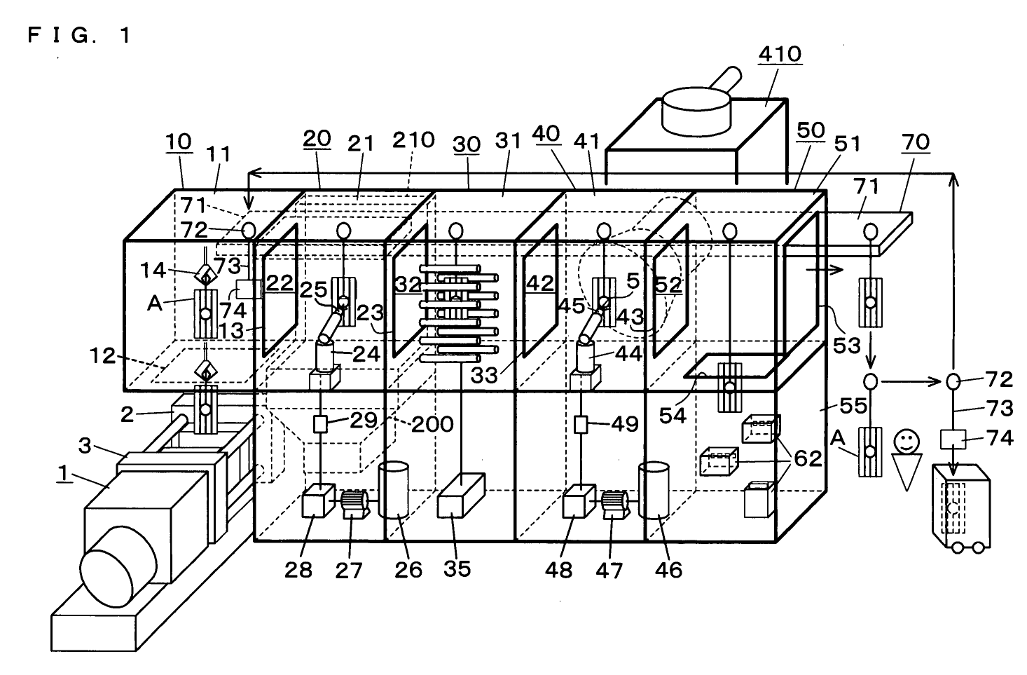

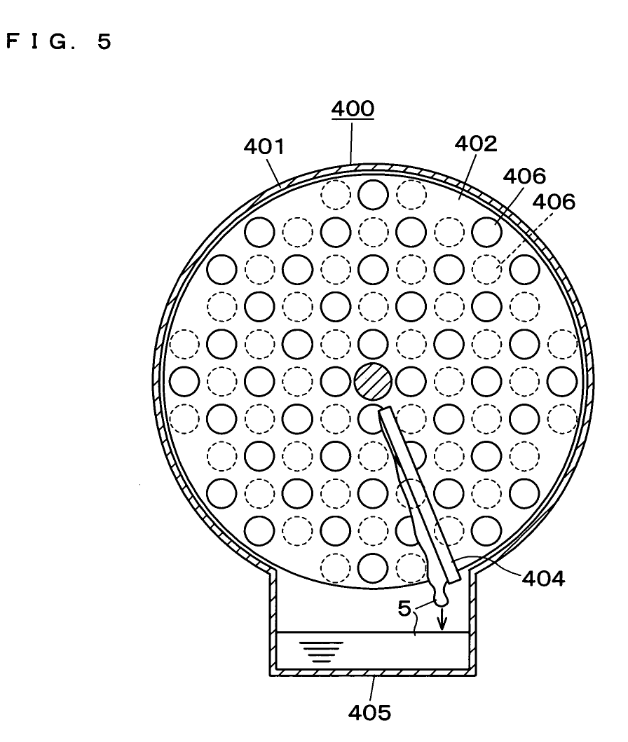

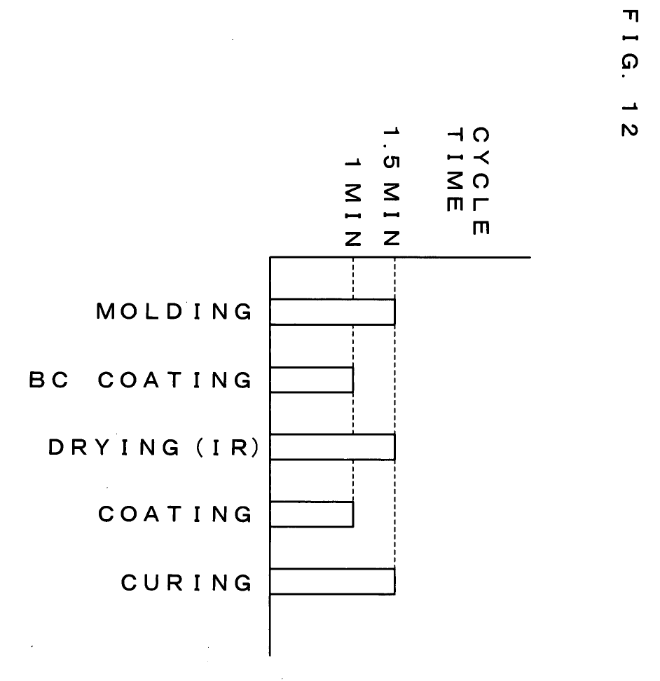

The coating plant and the coating process of Embodiment 1 will be described with reference to FIG. 1 to FIG. 14.

<<Plant for Coating Molded Articles>>

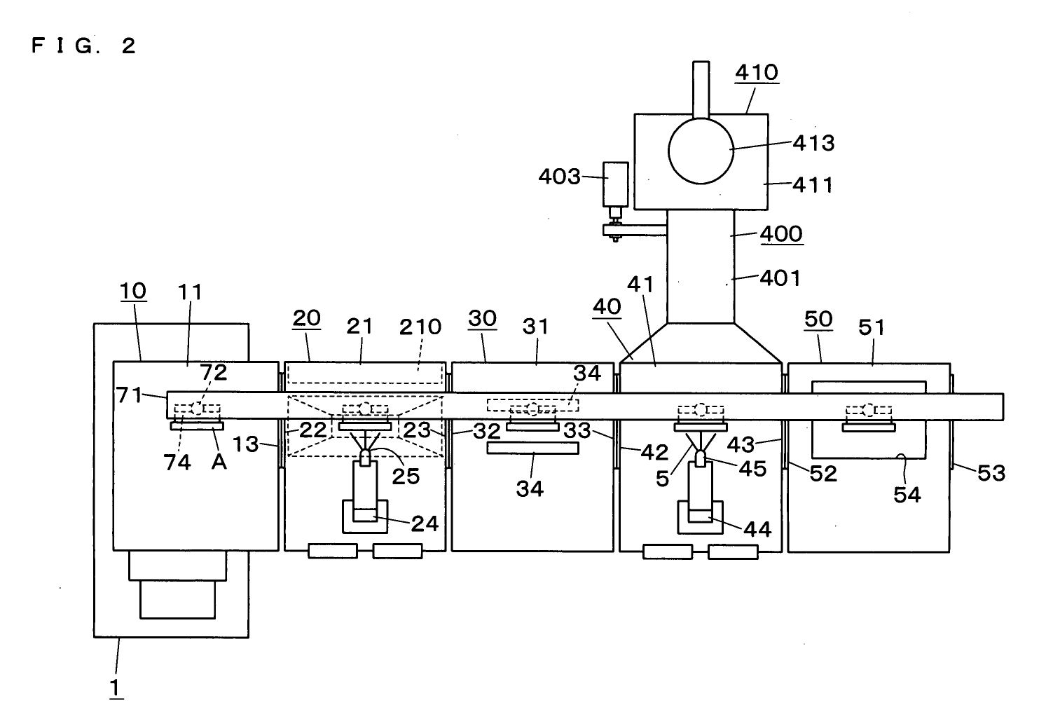

FIG. 1 and FIG. 2 schematically show the molding apparatus 1 in a molding equipment of molded articles and the entirety of the coating plant of Embodiment 1. Prior to the coating plant, here will be briefly described the molding apparatus 1, which produces the molded article A of a polymeric material. The molding apparatus 1, as shown in FIG. 1 and FIG. 2, performs an injection molding with a synthetic resin, and is provided with a stationary mold 2 and a moving mold 3 to be transversely opened/closed. Here, the molds 2 and 3 provided mold a radiator grille having a lattice pattern, i.e., a complicated exterior trim part of an automobile as one example of the molded article A. The molding cycle time by this molding apparatus 1 is about 1.5 minutes (1 to 2 minutes), for example. Here, the molding apparatus 1 should not be limited to that example, but the molding process may be a casting, blowing or slushing method. The polymeric material may be rubber or an elastomer, and the molded article may be one of various exterior trim parts such as a protector molding, a lamp cover or an emblem, or another.

The coating plant is constructed by arranging, sequentially from the molding apparatus 1, the unloader 10 for unloading the molded article A from the molding apparatus 1; the BC coating equipment 20 for coating the molded article A with the base coat coating material; the drying equipment 30 for drying the base coat coating material by heating it; the coating equipment 40 for coating the molded article A with the substantially solventless UV curable coating material; and the curing equipment 50 for curing the UV curable coating material by a UV irradiation. These equipments (10), (20), (30), (40) and (50) are arranged in the recited order from the molding apparatus 1 without any stock site between any of the equipments 10, 20, 30, 40 and 50. A UV curable coating material recovery equipment 400 is connected to the coating equipment 40. The coating plant is further provided with the transfer equipment 70 for transferring the molded article A automatically between the individual equipments 10, 20, 30, 40 and 50.

(Unloader 10)

The unloader 10 is constructed as a unit having a generally rectangular box-shaped casing 11. A molded article entrance 12 is opened in the lower face of the casing 11, and a molded article exit 13 is opened in one side face (i.e., in the right side face in FIG. 1). The unloader 10 is attached to the second floor of the subsequent BC coating equipment 20 so as to be positioned over the molding apparatus 1. The molded article entrance 12 is directed to the parting portion of the molds 2 and 3. In the casing 11, there are disposed a chuck 14 for chucking the molded article A, and a transfer equipment (although not shown) for transferring the chuck 14 between the parting portion of the molds 2 and 3 and a moving acceptor 74 of the later-described transfer equipment 70.

(Base Coat (BC) Coating Equipment 20)

The BC coating equipment 20 is constructed as a unit having a generally rectangular box-shaped casing 21. This casing 21 is made to have a two-floor structure having a second floor portion and a first floorportion by a partition disposed at a central height. In the second floor portion, a molded article entrance 22 is opened in one side face (i.e., in the left side face in FIG. 1) of the casing 21, and a molded article exit 23 is opened in the other side face (i.e., in the right side face in FIG. 1). In the second floor portion, there is disposed a well-known robot 24, which has a three-dimensional driven arm connected and supported by a plurality of articulations. To this robot 24, there is attached a spray nozzle 25 for spraying a base coat coating material to the molded article A. In the first floor portion, there is disposed a coating material feeder, which is composed of a base coat coating material tank 26, a pump 27, a base coat coating material heater 28, an electromagnetic valve 29 and their controller (although not shown) thereby to feed the spray nozzle 25 with the base coat coating material. This base coat coating material should not be especially limited but may preferably be lacquer containing a highly volatile solvent. The radiator grille or the molded article A may be coated with the base coat coating material only at its portion seen from the front face side. Therefore, only this front face side is spray-coated, but a small quantity of mist of the base coat coating material inevitably flies around to stick to the back side of the radiator grille. This BC coating cycle time by the BC coating equipment 20 can be substantially synchronized to about 1 minute (e.g., 0.5 to 1.5 minutes), for example, with the aforementioned molding cycle time by using the robot 24.

To the casing 21, there are connected a base coat coating material recoverer 200 for recovering the base coat coating material having failed to stick to the molded article A, and an exhauster 210. It is arbitrary whether the base coat coating material recovered by the base coat coating material recoverer 200 is discarded or utilized as an auxiliary material of the coating material (but it is difficult to reuse the recovered one as a pure bases coat coating material).

(Drying Equipment 30)

The drying equipment 30 is constructed as a unit having a generally rectangular box-shaped casing 31. This casing 31 is made to have a two-floor structure having a second floor portion and a first floor portion by a partition disposed at a central height. In the second floor portion, a molded article entrance 32 is opened in one side face (i.e., in the left side face in FIG. 1) of the casing 31, and a molded article exit 33 is opened in the other side face (i.e., in the right side face in FIG. 1). It is sufficient for the drying operation that the solvent in the aforementioned base coat coating material sufficiently volatilizes. In the second floor portion, therefore, IR (Infrared) lamps 34 are used as a heat source and juxtaposed to each other in the following manner. The base coat coating material sticks not only necessarily to the front face side of the radiator grille or the molded article A but also inevitably to the back side, as has been described hereinbefore. Therefore, it is necessary to heat and dry those two sides homogeneously. A quick drying operation is also needed for achieving the drying cycle time, as will be described in the following. Therefore, the IR lamps 34 are constructed of two groups: a lamp group having a plurality of (e.g., seven) transversely long lamps arranged longitudinally to face the front face side of the radiator grille; and a lamp group having a plurality of (e.g., six) transversely long lamps arranged longitudinally to face the back side of the radiator grille. In those two groups, moreover, the individual lamps are staggered to have different heights alternately. In the first floor portion, there is disposed a control power source 35 for supplying the IR lamps 34 with a controlled electric power. By the devices thus far described, the drying cycle time by the drying equipment 30 can be substantially synchronized to about 1.5 minutes (e.g., 0.5 to 2 minutes), for example, with the aforementioned molding cycle time.

(Coating Equipment 40)

The coating equipment 40 is constructed as a unit having a generally rectangular box-shaped casing 41. This casing 41 is made to have a two-floor structure having a second floor portion and a first floor portion by a partition disposed at a central height. In the second floor portion, a molded article entrance 42 is opened in one side face (i.e., in the left side face in FIG. 1) of the casing 41, and a molded article exit 43 is opened in the other side face (i.e., in the right side face in FIG. 1). In the second floor portion, there is disposed a well-known robot 44, which has a three-dimensionally driven arm connected and supported by a plurality of articulations. To this robot 44, there is attached a spray nozzle 45 for spraying a UV curable coating material 5 to the molded article A. In the first floor portion, there is disposed a coating material feeder, which is composed of a UV curable coating material tank 46, a pump 47, a UV curable coating material heater 48, an electromagnetic valve 49 and their controller (although not shown) thereby to feed the spray nozzle 45 with the UV curable coating material 5.

The UV curable coating material 5 is exemplified by a solventless clear coating material. The solventless type UV curable coating material is advantageous in that it can omit such a drying process for the solvent to volatilize before UV-cured as is needed by a solvent type UV curable coating material. However, the solventless type UV curable coating material is so expensive that the UV curable coating material recovery equipment 400 is provided for recovering the coating material in a reusable state, as will be described hereinafter. Here, the UV curable coating material 5 is blended with a photopolymerization initiator for UV curing and a UV absorbent for a weather resistance. The absorption band of the former and the excitation band of the latter are selected to have at least peak wavelengths shifted. In case the UV curable coating material has a high viscosity, this viscosity is lowered by heating the coating material with the heater 48.

For a reason like that in the aforementioned BC coating, the radiator grille or the molded article A is spray-coated only from its front face side, but a small quantity of mist of the UV curable coating material inevitably flies around to stick to the back side of the radiator grille. This coating cycle time by the coating equipment 40 can be substantially synchronized to about 1 minute (e.g., 0.5 to 2 minutes), for example, with the aforementioned molding cycle time by using the robot 44.

(UV Curable Coating Material Recovery Equipment 400)

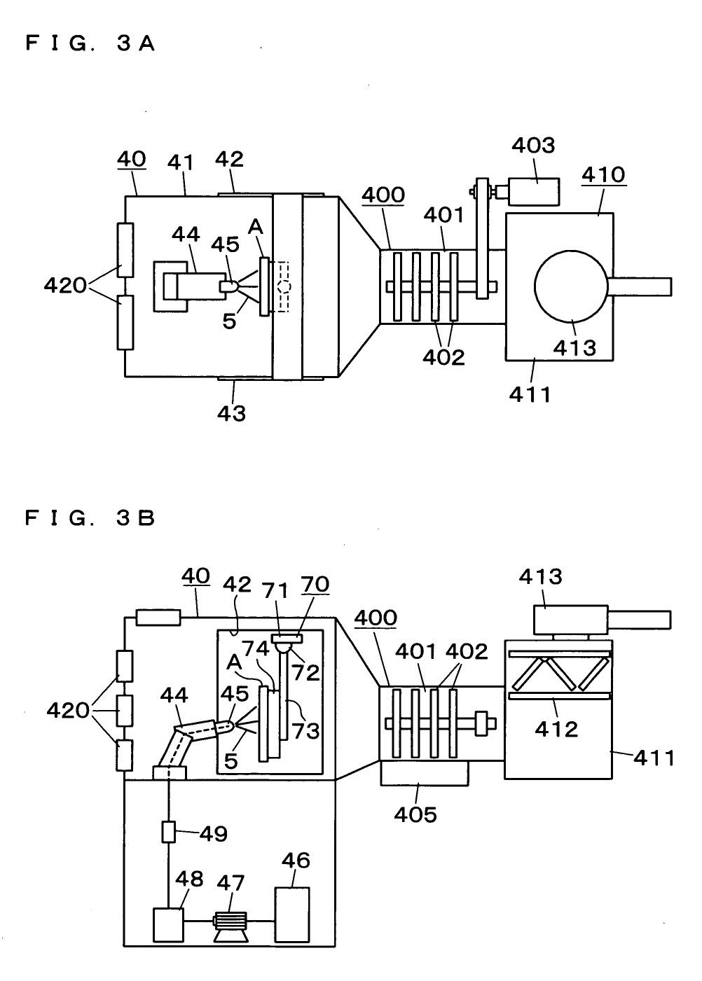

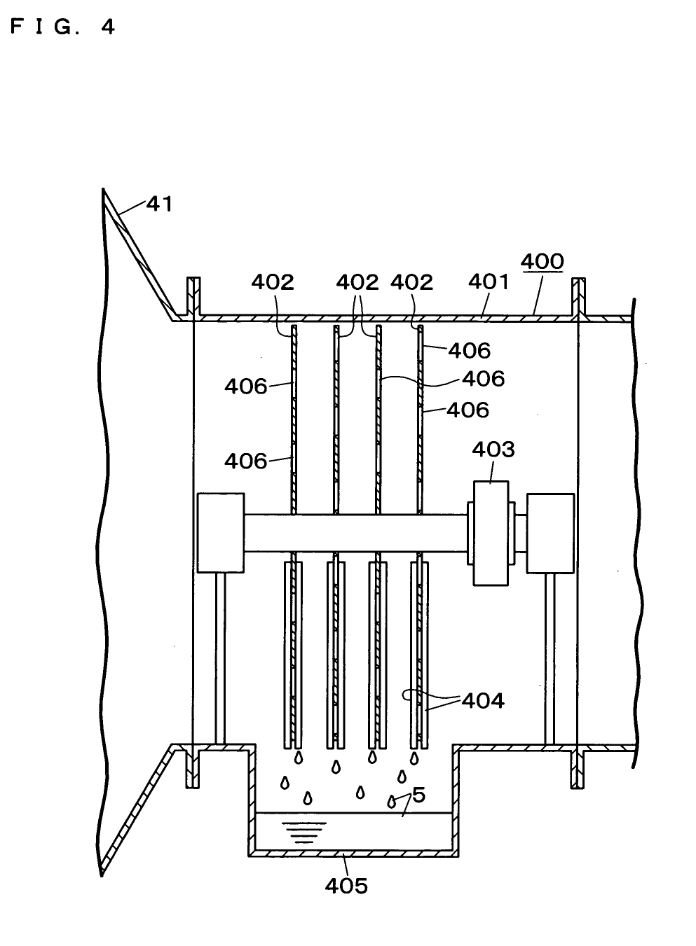

The UV curable coating material 5 has such a property as is not cured so long as it is not exposed to a UV. Therefore, the coating equipment 40 establishes an atmosphere, in which an ambient light containing a UV does not enter the casing 41. Specifically, the casing 41 is formed to have a dark room in its inside, and fresh air inlets 420 are formed in the side face (i.e., in the front side face in the shown example) of the casing 41. The fresh air inlets 420 are formed to have such an air permeable material or structure as shields the ambient light. The UV curable coating material recovery equipment 400 is provided for recovering the UV curable coating material 5 in the mist state, which has failed to stick to the molded article A or the article to be coated, in the spray-coating in said atmosphere, in an uncured state for reusing it as the UV curable coating material. As shown in FIG. 3 and FIG. 4, the UV curable coating material recovery equipment 400 is constructed to include: a cylindrical casing 401 connected to one side face (i.e., to the taper rear side face in the shown example) of the casing 41; a plurality of eliminators 402 rotatably born in the casing 401 so that they are spaced from each other and juxtaposed to each other; a turning driver 403 for turning the eliminators 402 together with their shaft; a plurality of scrapers 404 for scraping off the UV curable coating material 5 having stuck in a film shape to the surfaces of the individual eliminators 402; a recovery container 405 disposed below the casing 401 for reserving and recovering the UV curable coating material 5 scraped off; and an exhauster 410 for producing an air flow from the molded article A to the eliminators 402. In the casing 401 of the equipment 400, there is naturally established the atmosphere for shielding the ambient light containing the UV.

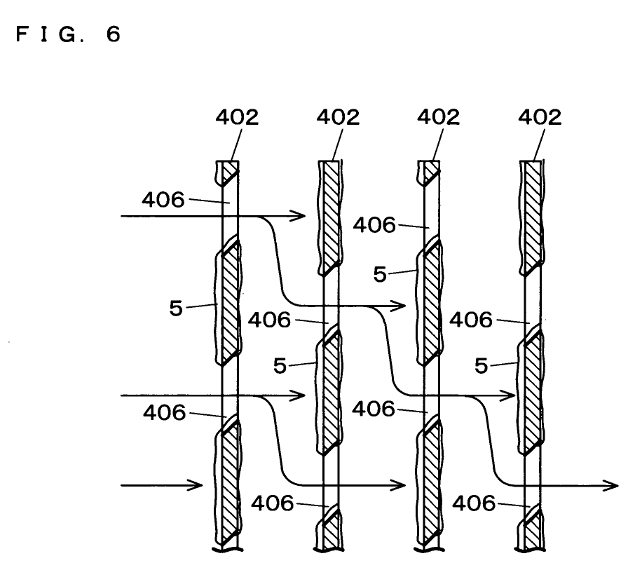

As shown in FIG. 4 to FIG. 6, each eliminator 402 is formed into a disc shape for generally blocking the internal section of the casing 401, and has a large number of air vents 406 formed dispersively. These air vents 406 are arranged in such a staggered shape that they may not be arrayed in their axial directions between the adjoining eliminators 402. As a result, the UV curable coating material 5 having passed an air vent 406 together with the air impinges upon the surface of the adjacent eliminator 402 to be easily trapped. Moreover, each air vent 406 is worked oblique at its inner edge (FIG. 6) so that the UV curable coating material 5 having stuck to the inner edge easily drops. The eliminators 402 have a diameter of 800 to 1,000 mm, for example, and a spacing between the adjoining eliminators is 10 to 50 mm, for example. The air vents 406 have a diameter of 20 to 40 mm, for example, and 100 to 200 air vents 406 are distributed in each eliminator 402, for example. One eliminator 402 having that numerical range has a trapping factor of about 40 to 60% so that the trapping factor of the UV curable coating material 5 by four eliminators 402 is about 87 to 98%, for example. In the case of this example, the proper number of the eliminators 402 is 3 to 6. Here, the trapping factor is a numeral varying with the change in that numerical range.

Each scraper 404 is formed into such an elongated spatulate shape as extends radially of each eliminator 402 and contacts with the front surface (i.e., the side confronting the molded article A) and the back surface (i.e., the opposite side). The scraper 404 itself is fixed, but the UV curable coating material having stuck in the film shape to the both surfaces of the eliminator 402 is scraped off by the scraper 404 as the eliminator 402 turns, so that it is reserved and recovered in the recovery container 405. The materials and the surface treatments of the eliminators 402 and the scrapers 404 are important factors for scraping off the UV curable coating material smoothly and are preferably adopted to be excellent in low friction coefficients, wear resistances, corrosion resistances and so on. In this example, the eliminators 402 are made of SS (JIS: rolled steel for general structures) and are plated with nickel. The scrapers 404 are made of an NC nylon resin.

The exhauster 410 is constructed to include: a casing 411 connected to the terminal end of the casing 401; a filter 412 disposed in the casing 411; and an exhaust fan 413 for suctions in the direction to the outside of the filter 412. By these suctions, the air flow is established in the order of the fresh air inlets 420→the inside of the casing 41→the inside of the casing 401→the inside of the casing 411→the ambient air. The UV curable coating material in the mist state having failed to stick to the molded article A flows together with that air flow to the eliminators 402.

(Curing Equipment 50)

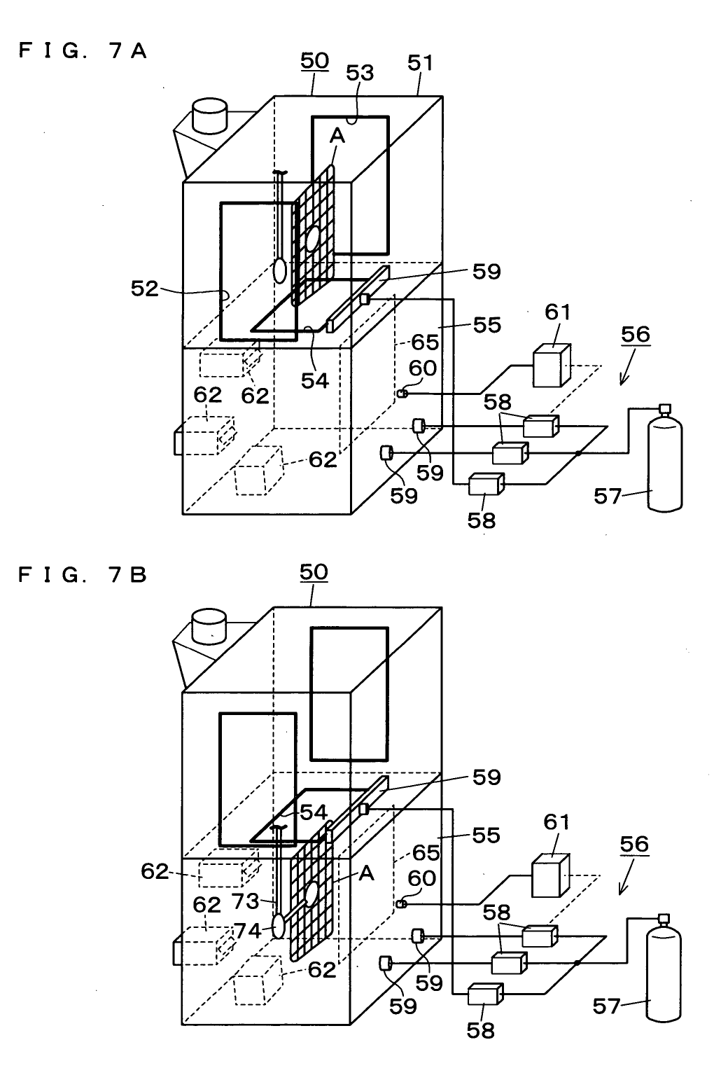

The curing equipment 50 is constructed as a unit having a generally rectangular box-shaped casing 51. This casing 51 is made, as shown in FIG. 7, to have a two-floor structure having a second floor portion and a first floor portion by a partition having a communication port 54 and disposed at a central height. In the second floor portion, a molded article entrance 52 is opened in one side face (i.e., in the left side face in FIG. 1) of the casing 51, and molded article exits 53 are opened in the other two side faces (i.e., in the right and front side faces in FIG. 1).

The second floor portion has a cavity, which may be provided with a power source for a UV lamp 62, a movement controller, an output controller and so on, as will be described later.

The first floor portion is the body of the curing equipment 50. The first floor portion of the casing 51 itself is a curing bath 55 for purging (or charging) an inert gas. In the curing operation, it is a key point how to irradiate the molded article A made of a synthetic resin weak in heat with a UV so that the molded article A may not be excessively heated. It is another key point how to irradiate the molded article A such as the radiator grille having the complicated lattice shape a so homogeneously as to reach the dark area such as the deep portion of the lattice shape a which is hard to receive the UV. Therefore, the curing equipment 50 of this example is constructed to incorporate the following five items.

(1) Chute Feed Method

Here is adopted the chute feed method, in which the casing 51 is made to have the two-floor structure so that the molded article A may be dropped from the communication port 54 of the partition into the curing bath 55 in the first floor portion and cured with the UV. This method is adopted in view of the properties of the inert gas to be used in the later-described purge. By this chute feed method, moreover, it is effective to prevent the leakage of the UV from the corresponding equipment and process to the preceding coating equipment and process. The curing bath 55 has an internal capacity of about 1 m³ and a floor size of about 1 m×about 1.5 m.

(2) Purge by Inert Gas

The existence of oxygen in the atmosphere at the UV irradiation time blocks the UV cure of the coating material and causes formation of the uncured portion. To the curing bath 55, therefore, there is connected an inert gas supplier 56 for purging the bath inside with the inert gas. This inert gas supplier 56 is constructed to include an inert gas tank 57, a plurality of electromagnetic valves 58 and discharge ports 59. Some of the discharge ports 59 are opened in the casing 51 to inject the inert gas fully. The remaining discharge ports 59 are branched and opened in the communication port 54 of the partition, and inject the inert gas to cross the communication port 54 thereby to prevent the inflow of air from the second floor portion. The curing bath 55 is provided with an oxygen sensor 60, and a purge controller 61 for opening/closing the electromagnetic valves 58 so that the oxygen concentration detected by the oxygen sensor 60 may be at a predetermined value or lower. In this example, the inert gas is exemplified by a carbonic acid gas (a carbon dioxide). This carbonic acid gas is heavier than air, so that it has such a property as continuously accumulates in the curing bath 55 and is reluctant to escape from the upper communication port 54. Therefore, the carbonic acid gas is advantageous in that it can be supplied not continuously but intermittently. Incidentally, what is generally used for the purge is a nitrogen gas, which is lighter than the air so that it easily escapes from the communication port 54.

(3) UV Lamps and Lamp Mover

The UV lamps 62 are disposed in the curing bath 55 in the following manner. As has been described hereinbefore, the UV curable coating material in the dark area, which is hard to be exposed to the UV, such as the deep portion of the radiator grille of the lattice shape a has to be homogeneously exposed to the UV. In order to achieve the later-described curing cycle time, moreover, a rapid curing is necessary. Therefore, the two UV lamps 62 and one UV lamp 62 are disposed to have their mutual positions disposed so longitudinally and transversely that the former two may face the front face of the radiator grille and that the latter one may face up the front face of the radiator grille. Thus, the two UV lamps 62 and the one UV lamp 62 can irradiate the front faces in the different directions. Moreover, the general electrode type UV lamps cannot be freely moved, but this example employs the electrodeless UV lamps 62 which can be freely moved. Specifically, the UV lamps of the example are the electrodeless lamps of FUSION Corporation. The individual UV lamps 62 are mounted on a lamp mover 63, by which the distance of the light sources from the molded article A can be changed. By the lamp mover 63, moreover, the individual UV lamps can be turned right and left, tilted longitudinally and transversely, changed in the angle of elevation, moved upward and downward, and moved right and left. The moving ranges of the UV lamps 62 are, for example, a light source distance of 50 to 200 mm, a right-and-left turn of ±30 degrees, longitudinal/transverse tilts of ±45 degrees, an angle of elevation of ±30 degrees, a vertical movement of 500 mm, and a right-and-left movement of 200 mm. By thus making the UV lamps 62 movable, the lamp arrangement can be optimized flexibly for the shape of the molded article A (i.e., the radiator grille or another molding article).

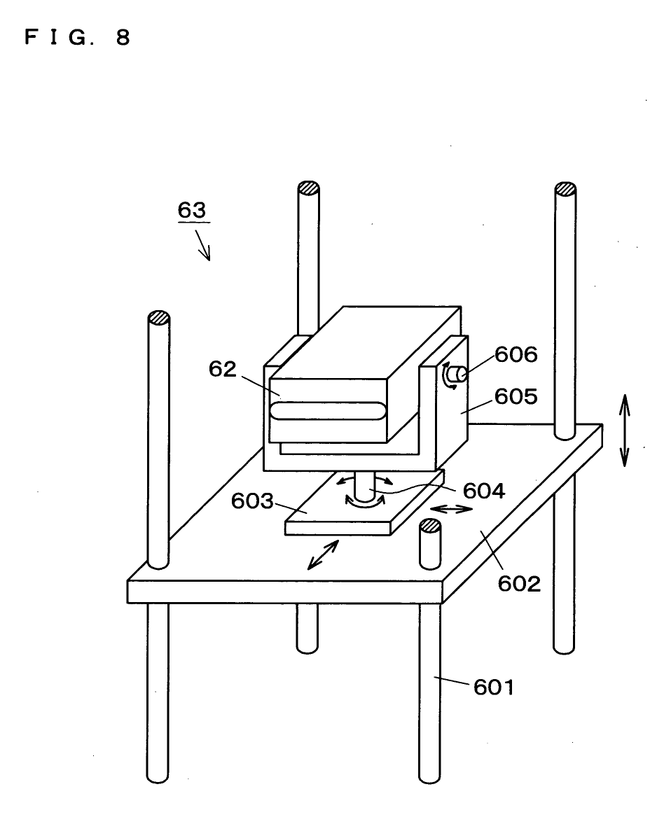

The lamp mover 63 of this example is constructed, as shown in FIG. 8, to include: a lifting platform 602 enabled to move upward and downward by the guide of guide poles 601 erected in the curing bath 55; a carriage 603 enabled to move back and forth, and right and left on the lifting platform 602; a moving vertical shaft 604 made turnable and tiltable while being supported at its lower end on the carriage 603; and a moving horizontal shaft 606 turnably mounted in a support bed 605 attached to the upper end of the moving vertical shaft 604, for supporting and turning the UV lamp 62. These components are individually provided with drivers (although not shown) using motors or the like. The UV lamp 62 is moved upward and downward by the vertical movements of the lifting platform 602; the light source distance of the UV lamp 62 is changed by the back-and-forth movements of the carriage 603; the UV lamp 62 is moved right and left by the right-and-left movement of the carriage 603; the UV lamp 62 is turned right and left by the turns of the moving vertical shaft 604; the UV lamp 62 is tilted longitudinally and transversely by the inclination of the moving vertical shaft 604; and the elevation angle of the UV lamp 62 is changed by the turns of the horizontal shaft 606.

(4) Movement of Molded Article

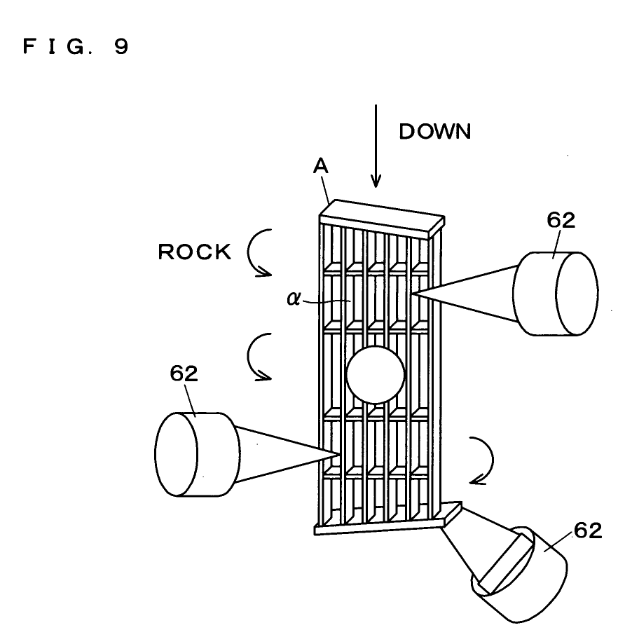

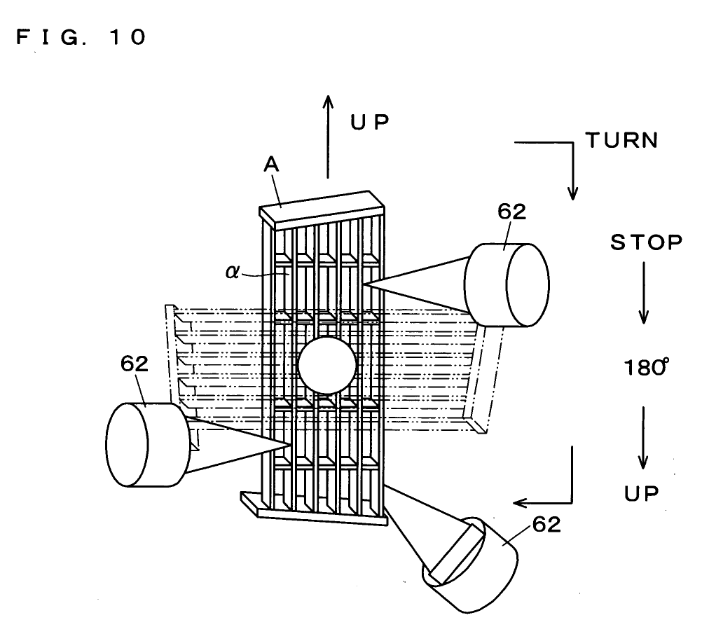

The moving acceptor 74 of the later-described transfer equipment 70 enters the curing bath 55 while holding the molded article A and then has functions to rock, to turn back (or turn upside down, as belongs to one mode of the following turn), to turn, to move back and forth, to move right and left, and to move upward and downward the molded article A. By these functions, the UV is applied so far as the UV curable coating material of the dark area while rocking the molded article A, as shown in FIG. 9. In order to make the internal capacity of the curing bath 55 as small as possible to reduce the quantity of the inert gas necessary for the purge, as described above, and to utilize the UV efficiently, the molded article A is exposed to the UV while being turned back and turned, as shown in FIG. 10.

(5) Reflecting Plate

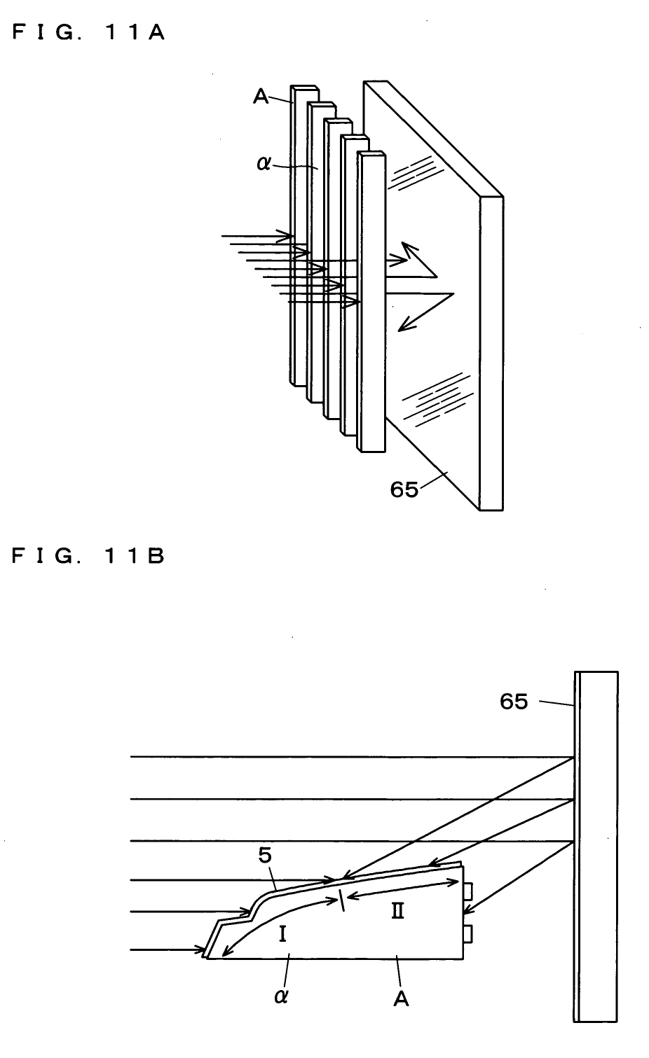

The mist of the UV curable coating material 5 inevitably sticks even to the back face of the radiator grille or the molded article A, as has been described hereinbefore, the back face side has also to be irradiated with the UV. However, the mist is of a small quantity, and it is inefficient to provide the expensive UV lamp for curing the mist stuck to the back face side. For an efficient utilization of the UV coming from the UV lamp 62 on the front face side, therefore, a reflecting plate (or mirror) 65 for reflecting the UV onto the back face side of the molded article A is arranged, as shown in FIG. 11, so that the UV curable coating material having stuck to the back face of the molded article A and the aforementioned dark area is cured with the secondary UV reflected on the reflecting plate 65. In FIG. 11B, letter I designates the range of the UV curable coating material 5 to be cured with the direct UV (or the primary UV) coming from the UV lamp 62, and letter II designates the range of the UV curable coating material 5 to be cured with the secondary UV reflected on the reflected plate 65.

(Transfer Equipment 70)

At the ceiling portions of the individual second floor portions of the unloader 10, the BC coating equipment 20, the drying equipment 30, the coating equipment 40 and the curing equipment 50 thus far described, there is disposed the continuous transfer equipment 70. This transfer equipment 70 is constructed to include: a continuous rail 71; a mover 72 for moving along the rail 71; a hanging member 73 hanging vertically from the mover 72; and the moving acceptor 74 attached to the lower end of the hanging member 73. The mover 72 has a function to move the hanging member 73 upward and downward. The moving acceptor 74 has a function to accept and support the molded article A and the aforementioned functions to rock, to turn back, to turn, to move back and forth, to move right and left, and to move upward and downward the molded article A.

(Arrangement of Individual Equipments)

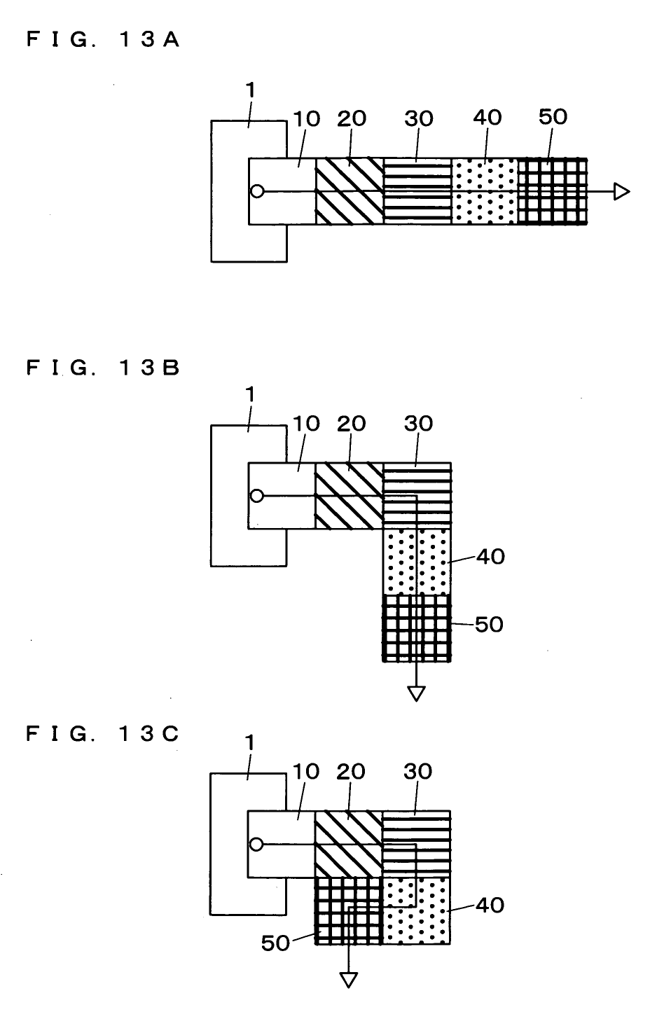

The aforementioned individual equipments 10, 20, 30, 40 and 50 are linearly arranged and jointed in the recited order so that their molded article exits and entrances are registered with each other (FIG. 1 and FIG. 13A). The individual equipments 10, 20, 30, 40 and 50 may also be constructed such that one side face of another unit can be jointed to a selected one of two or three side faces of at least one unit of the equipments. Then, the units can be changed in their plan arrangements, for example, an L-shaped plan view as shown in FIG. 13B, or a C-shaped plan view as shown in FIG. 13C.

Moreover, the units of the individual equipments 20, 30, 40 and 50 can be interchangeably arranged so that they can select the following three arrangements.

(1) The BC coating equipment 20, the drying equipment 30, the coating equipment 40 and the curing equipment 50 are arranged and jointed sequentially in the recited order (FIG. 1 and FIG. 13A). The coating method of this case is the later-described individual processes, i.e., the so-called “2-coats and 2-bakes”.

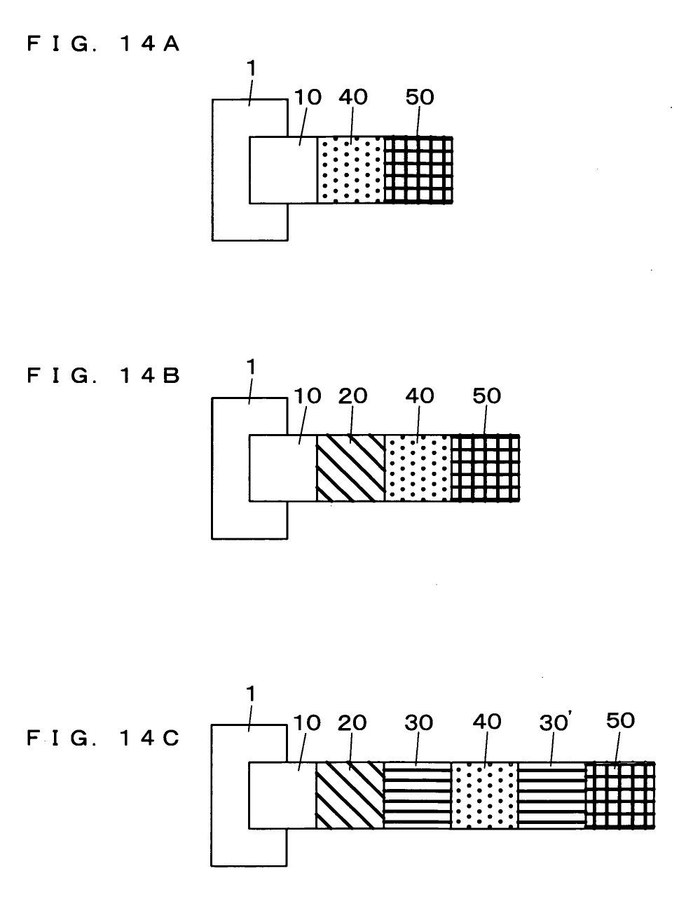

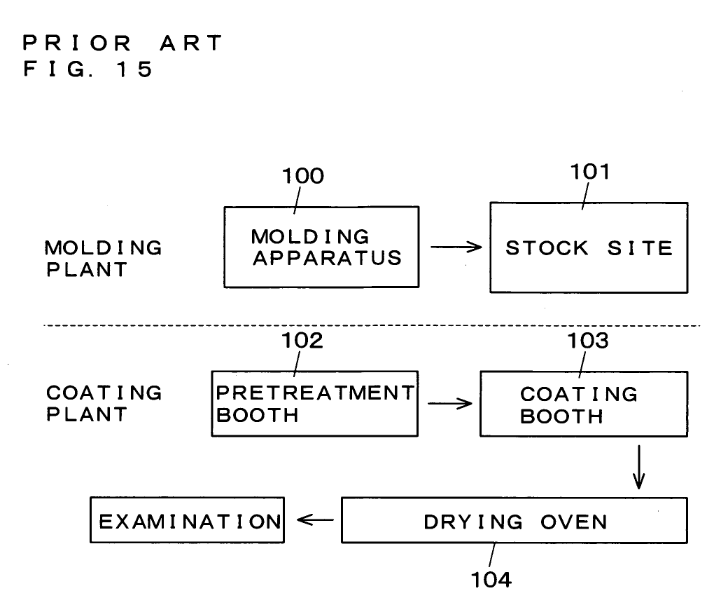

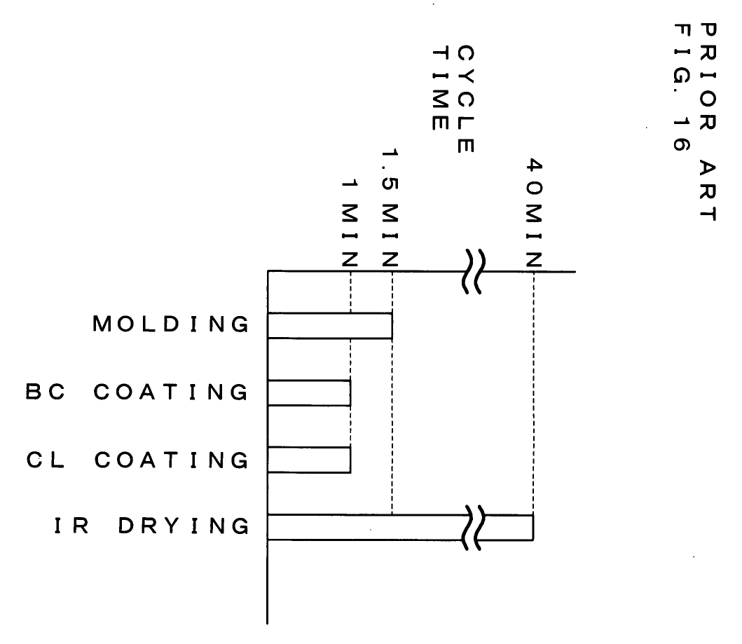

(2) Excepting the BC coating equipment 20 and the drying equipment 30, the coating equipment 40 and the curing equipment 50 are arranged and jointed sequentially in the recited order (FIG. 14A). The coating method of this case is the later-described composition of the coating process and the curing process, i.e., the so-called “1-coat and 1-bake”.

(3) Excepting the drying equipment 30, the BC coating equipment 20, the coating equipment 40 and the curing equipment 50 are arranged and jointed sequentially in the recited order (FIG. 14B). The coating method of this case is the later-described composition of the BC coating process, the coating process and the curing process, i.e., the so-called “2-coats and 1-bake”. In this case, the base coat coating material is not IR-dried (that is, the solvent of the base coat coating material is adjusted in advance so as to make the IR drying process unnecessary).

<<Process For Coating A Molded Article>>

Here will be described a process for coating a molded article to be performed by using the plant thus constructed. Prior to this process, the radiator grille or the molded article A is injection-molded for a molding cycle time of about 1.5 minutes (e.g., 0.5 to 2 minutes), and the molds 2 and 3 are opened.

1. Unloading Process: The chuck 14 of the unloader 10 moves down between the molds 2 and 3, chucks and unloads the molded article A, and moves up again to transfer the molded article A one by one to the moving acceptor 74 of the transfer equipment 70. This unloading cycle time is several seconds to 10 and several seconds, which are extremely shorter than the cycle times of the remaining cycle times, so that it can be substantially ignored for the synchronizations. When the unloader 10 handles several molded articles, these articles are separated by cutting the gates after the unloading operation and are then likewise transferred one by one.

2. Base Coat (BC) Coating Process: The transfer equipment 70 transfers the molded article A one by one to the BC coating equipment 20, in which the molded article A is coated with the base coat coating material by the spray nozzle 25 attached to the robot 24 fora BC coating cycle time of about 1 minute (e.g., 0.5 to 1.5 minutes).

3. Drying Process: The transfer equipment 70 transfers the molded article A after the BC coating, to the drying equipment 30, in which the base coat coating material of the molded article A is dried for a drying cycle time of about 1.5 minutes (e.g., 1 to 2 minutes) by the IR lamp 34.

4. Coating Process: The transfer equipment 70 transfers the molded article A after the drying operation, one by one to the coating equipment 40, in which the molded article A is coated with the solventless type UV curable coating material 5 by the spray nozzle 45 attached to the robot 24 for a coating cycle time of about 1 minute (e.g., 0.5 to 1.5 minutes). At this time, the coating equipment 40 receives neither the ambient light containing the UV nor the UV coming from the curing equipment 50. Therefore, the UV curable coating material recovery equipment 400 recovers the UV curable coating material 5 having failed to stick to the molded article A, as the UV curable coating material in the reusable uncured state. This makes it possible to improve the using efficiency of the UV curable coating material, to reduce the cost and to lighten the waste disposal.

5. Curing Process: The transfer equipment 70 transfers the molded article A after the coating with UV, one by one to the curing equipment 50. In this curing equipment 50, the transfer equipment 70 lowers the molded article A through the second floor portion and the communication port 54 into the curing bath 55 in the first floor portion. The oxygen having stuck to the molded article A is blown off, when the molded article A passes the communication port 54, with the inert gas which is discharged from the discharge ports 59 formed in the communication port 54. In the curing bath 55 having been purged with the inert gas, moreover, the UV curable coating material 5 (or the coated film) of the molded article A is irradiated with the UV by the UV lamps 62, as has been described hereinbefore, so that it is cured for a curing cycle time of about 1.5 minutes (e.g., 1 to 2 minutes). At this time, the curing equipment 50 performs the UV irradiation incorporating the aforementioned five items so that the following advantages can be obtained.

A: The UV irradiation can be efficiently done in a proper UV intensity and for a proper short time, so that the molded article A is not excessively heated and is hard to have a thermal deformation.

B: Even on the molded article A of a complicated shape, the UV curable coating material 5 can be homogeneously cured, and the UV curable coating material of the dark area such as the deep portion of the lattice shape a can also be reliably exposed to the UV and cured.

C: By the two-floor structure to employ the chute feed to the first floor portion, it is possible to improve the reserving property of the inert gas and to prevent the UV leakage into the coating equipment 40.

D: The number of the UV lamps 62 can be reduced, and size of the curing bath 55 can be minimized to reduce the space of the curing equipment 50 (or the installation area) and to lower the cost.

6. Discharging Process: The transfer equipment 70 discharges the molded article A after the curing operation, one by one from the molded article exit 53. The worker detaches the molded article A from the moving acceptor 74 of the transfer equipment 70 and stocks it. The moving acceptor 74 circulates to return to the unloader 10.

The individual processes thus far described are performed continuously and sequentially so that they run substantially always. When one molded article is transferred from the BC coating process to the drying process, the succeeding one molded article is transferred to the BC coating process, and the preceding one molded article is transferred from the drying process to the coating process.

Thus, the BC coating cycle time, the drying cycle time, the coating cycle time and the curing cycle time are individually set within ranges of 0.2 to 5 times (preferably, ranges of 0.5 to 2 times) as long as the molding cycle time, so that the molded article is transferred sequentially one by one to the BC coating process, the drying process, the coating process and the curing process thereby to eliminate the stock between the individual processes. Thus, the stock site can be eliminated to make the equipment arranging space compact, to reduce the stocking troubles and to shorten the lead time. Moreover, the cycle times of the individual processes including the drying cycle time can also be substantially synchronized to realize one-article transfer of the molded article, and to make the drying equipment compact and highly efficient.

Moreover, the individual equipments 20, 30, 40 and 50 are constructed as the units having the casings 21, 31, 41 and 51 of the two-floor structure, so that the molded article A can smoothly pass through the second floor portions of the individual equipments. As mentioned above, the curing equipment 50 can also easily adopt the chute feed method into the first floor portion. Moreover, the spaces for the units can be miniaturized (or the areas can be reduced) by housing the parts for the controls in the first floor portions of the individual equipments.

The present invention should not be limited to the embodiment thus far described but can be embodied by suitably changing it within the scope of the invention in the following manners.

(1) A solvent type containing a solvent can be used as the UV curable coating material 5. In this case, a solvent drying equipment 30′ like the drying equipment 30 is additionally interposed between the coating equipment 40 and the curing equipment 50, as shown in FIG. 14C, so that the solvent in the UV curable coating material 5 can be volatilized by that solvent drying equipment 30′. Then, the advantage of the aforementioned one-article transfer can be obtained.

(2) The molded article entrances or exits of the individual equipments 20, 30, 40 and 50, or the communication port 54 of the curing equipment 50 are merely opened but may be opened/closed with an opening/closing device. Especially by employing the opening/closing type in any port between the first floor portions of the coating equipment 40 and the curing equipment 50, the UV leakage from the UV lamps 62 to the coating equipment 40 can be reliably blocked.

(3) The invention can be practiced even if the individual equipments 20, 30, 40 and 50 are made to have a one-floor structure. In this case, it is preferred to adopt countermeasures (e.g., the opening/closing type of the ports or the shielding plates) against the UV leakage or the countermeasures (e.g., the opening/closing type of the ports) against the inert gas leakage.

1. A process for coating a molded article comprising:
a coating process of coating a molded article molded of a polymer material with an ultraviolet (UV) curable coating material; and
a curing process of curing said UV curable coating material by a UV irradiation,
wherein a coating cycle time of said coating process and a curing cycle time of said curing process are individually set within a range of 0.2 times to five times with respect to a molding cycle time of said molded article,
whereby the molded article is sequentially transferred one by one to said coating process and said curing process thereby to eliminate any stocking between said individual processes.

2. A process for coating a molded article according to claim 1, further comprising:
a base coat (BC) coating process of coating said molded article with a base coat coating material; said BC coating process being operated prior to said coating process;
wherein a BC coating cycle time of said BC coating process is set within a range of 0.2 times to five times with respect to the molding cycle time of said molded article,
whereby the molded article is sequentially transferred one by one to said BC coating process, said coating process and said curing process thereby to eliminate any stocking between said individual processes.

3. A process for coating a molded article according to claim 2, further comprising: a drying process of drying said base coat coating material by heating the same, said drying process being operated after said BC coating process and prior to said coating process;
wherein a drying cycle time of said drying process is set within a range of 0.2 times to five times with respect to the molding cycle time of said molded article,
whereby the molded article is sequentially transferred one by one to said BC coating process, said drying process, said coating process and said curing process thereby to eliminate any stocking between said individual processes.

4. A plant for coating a molded article comprising:
an unloader for unloading a molded article from a molding apparatus for molding said molded article of a polymer material;
a coating equipment for coating said molded article with an ultraviolet (UV) curable coating material;
a curing equipment for curing said UV curable coating material by a UV irradiation, said unloader, said coating equipment and said curing equipment being sequentially arranged in the recited order from said molding apparatus through no stock site between any ones of the individual equipments; and
a transfer equipment for transferring the molded article automatically between said individual equipments,
wherein a coating cycle time by said coating equipment and a curing cycle time by said curing equipment are individually set within a range of 0.2 times to five times with respect to a molding cycle time by said molding apparatus.

5. A plant for coating a molded article according to claim 4, further comprising: a base coat (BC) coating equipment for coating said molded article with a base coat coating material; said BC coating equipment being arranged between said unloader and said coating equipment through no stock site between any ones of the individual equipments,
wherein said transfer equipment transfers the molded article automatically between said individual equipments, and
wherein a BC coating cycle time by said BC coating equipment is set within a range of 0.2 times to five times with respect to the molding cycle time by said molding apparatus.

6. A plant for coating a molded article according to claim 5, further comprising: a drying equipment for drying said base coat coating material by heating the same; said drying equipment being arranged between said BC coating equipment and said coating equipment through no stock site between any ones of the individual equipments,
wherein said transfer equipment transfers the molded article automatically between said individual equipments, and
wherein a drying cycle time by said drying equipment is set within a range of 0.2 times to five times with respect to the molding cycle time by said molding apparatus.

7. A plant for coating a molded article comprising:
an unloader for unloading a molded article molded of a polymer material from a molding apparatus;
a base coat (BC) coating equipment for coating said molded article with a base coat coating material;
a drying equipment for drying said base coat coating material by heating the same;
a coating equipment for coating said molded article with an ultraviolet (UV) curable coating material; and
a curing equipment for curing said UV curable coating material by a UV irradiation, said unloader, said BC coating equipment, said drying equipment, said coating equipment and said curing equipment being individually constructed as units,
wherein the units of said individual equipments are so interchangeably assembled as to make the following three arrangements selectively:
(1) the unloader, the BC coating equipment, the drying equipment, the coating equipment and the curing equipment are sequentially arranged and jointed in the recited order;
(2) the unloader, the coating equipment and the curing equipment are sequentially arranged and jointed in the recited order excepting the BC coating equipment and the drying equipment; or
(3) the unloader, the BC coating equipment, the coating equipment and the curing equipment are sequentially arranged and jointed in the recited order excepting the drying equipment.

8. A plant for coating a molded article according to claim 7, wherein the units of said individual equipments are formed to have generally rectangular box-shaped casings, and wherein one side face of another unit can be jointed to a selected one of two or three side faces of at least one unit,
whereby the plan arrangement of the individual units can be changed.
